(19) United States
(12) Patent Application Publication
(10) Pub. No.: US 2026/0313577 A1
(43) Pub. Date: Oct. 8, 2026

(54) METHODS AND APPARATUS OF REENABLING N1 MODE CAPABILITY AFTER NO SLICES BEING AVAILABLE IN WIRELESS COMMUNICATIONS

(71) Applicant: MEDIATEK SINGAPORE PTE. LTD., Singapore (SG)

(72) Inventors: Puneet ., Bengaluru (IN); Yuan-Chieh LIN, Hsinchu City (TW)

(73) Assignee: MEDIATEK SINGAPORE PTE. LTD., Singapore (SG)

(21) Appl. No.: 19/474,075

(22) PCT Filed: Jun. 17, 2024
(86) PCT No.: PCT/CN2024/099516

§ 371 Date: Oct. 9, 2025

(30) Foreign Application Priority Data
Jul. 3, 2023 (IN) 202321044516

(51) Int. Cl. H04W 60/00

(52) U.S. Cl. CPC H04W 60/001; H04W 60/002

(57) ABSTRACT

Techniques pertaining to reenabling NI mode capability after no slices being available in mobile communications are described. An apparatus (e.g., a UE) disables a network mode capability for a currently camped network over an access due to no network slice being available for the network. The UE also memorizes an identity of the network for which the network mode capability is disabled due to no network slice being available. Moreover, the UE starts a timer for reenabling the network mode capability responsive to the network mode capability being disabled due to no network slice being available. The UE further removes the memorized identity of the network for which the network mode capability is disabled due to no network slice being available upon the expiry of timer.

### CROSS REFERENCE TO RELATED PATENT APPLICATION(S)

The present disclosure claims the priority benefit of Indian Patent Application No. 202321044516, filed 3 Jul. 2023, respectively, the content of which herein being incorporated by reference in its entirety.

### TECHNICAL FIELD

The present disclosure is generally related to mobile communications and, more particularly, to reenabling N1 mode capability after no slices being available in mobile communications.

### BACKGROUND

In wireless communications such as mobile communications under the current 3^{rd} Generation Partnership Project (3GPP) specification, when an initial registration procedure or mobility registration procedure or network-initiated de-registration procedure is rejected with a 5^{th} Generation Mobility Management (5GMM) cause #62 (no network slices available), a user equipment (UE) receiving the rejected network slice selection assistance information (NSSAI) in the REGISTRATION REJECT message is to take corresponding actions based on the rejection cause in the rejected single-network slice selection assistance information (S-NSSAI)(s). The S-NSSAI(s) may be one or more of the following: “S-NSSAI not available in the current PLMN or SNPN”, “S-NSSAI not available in the current registration area”, “S-NSSAI not available due to the failed or revoked network slice-specific authentication and authorization”, and “S-NSSAI not available due to maximum number of UEs reached.” When a registration reject or network-initiated de-registration is received with a 5GMM cause #62, the UE may disable its N1 mode capability according to the current 3GPP specification. However, it is not defined that for how much time a particular public land mobile network (PLMN) will be disabled. Additionally, it is not defined how to ensure the UE can perform periodic or background scan (e.g., N1 mode should not be disabled for more than a search time T). Moreover, it is not defined as to when to enable the N1 mode capability such as, for example, switching off, universal subscriber identity module (USIM) removal, or entry being updated in “list of subscribers”. Therefore, there is a need for a solution of reenabling N1 mode capability after no slices being available in mobile communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions pertaining to reenabling N1 mode capability after no slices being available in mobile communications. It is believed that implementations of one or more of the schemes proposed herein may address or otherwise alleviate the issues described above.

In one aspect, a method may involve a UE disabling a network mode capability for a currently camped network over an access due to no network slice being available for the network. The method may also involve the UE memorizing an identity of the PLMN or SNPN for which the N1 mode capability is disabled due to no network slice being available. The may additionally involve the UE starting a timer for reenabling the network mode capability and removing the memorized identity of the network for which the network mode capability is disabled due to no network slice being available upon the expiry of timer.

In another aspect, a method may involve a UE disabling an N1 mode capability for a currently camped network over a type of access due to no network slice being available for the network. The method may also involve the UE memorizing an identity of the network for which the N1 mode capability is disabled due to no network slice being available.

It is noteworthy that, although the description provided herein may be in the context of certain radio access technologies, networks, and network topologies such as 5^{th} Generation (5G)/New Radio (NR)/Beyond Fifth-Generation (B5G) mobile communications, the proposed concepts, schemes and any variation(s)/derivative(s) thereof may be implemented in, for and by other types of radio access technologies, networks and network topologies such as, for example and without limitation, 4^{th} Generation (4G)/Long-Term Evolution (LTE), LTE-Advanced, LTE-Advanced Pro, Internet-of-Things (IoT), Narrow Band Internet of Things (NB-IOT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of a second example process in accordance with an implementation of the present disclosure.

FIG. 4 is a flowchart of a second example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to reenabling N1 mode capability after no slices being available in mobile communications. According to the present disclosure, a number of possible solutions may be implemented separately or jointly. That is, although these possible solutions may be described below separately, two or more of these possible solutions may be implemented in one combination or another.

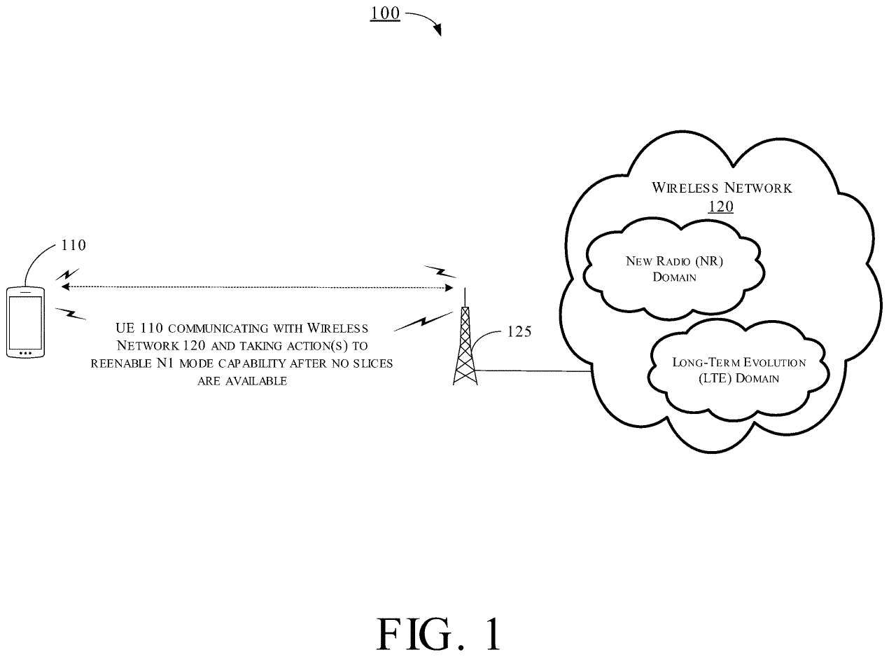

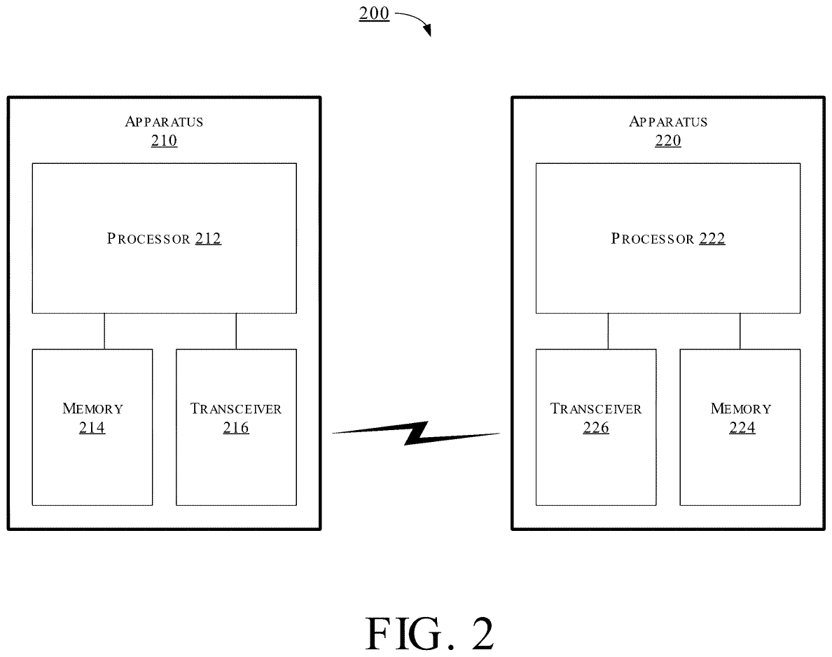

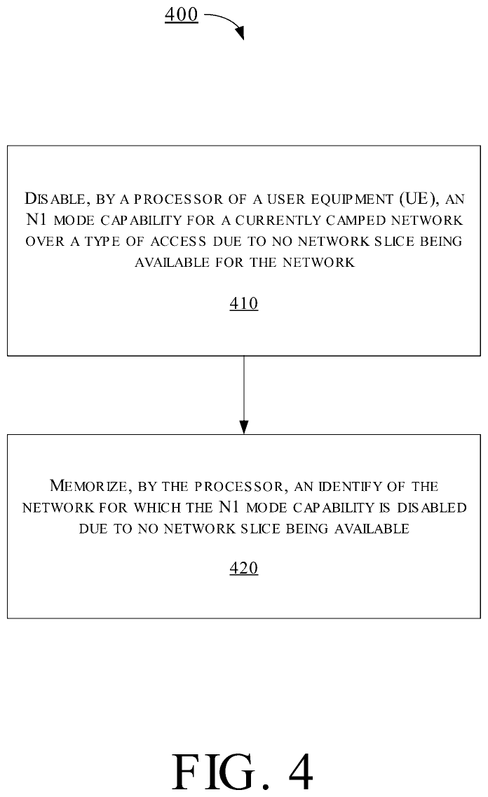

FIG. 1 illustrates an example network environment 100 in which various solutions and schemes in accordance with the present disclosure may be implemented. FIG. 2~FIG. 4 illustrate examples of implementation of various proposed schemes in network environment 100 in accordance with the present disclosure. The following description of various proposed schemes is provided with reference to FIG. 1~FIG. 4.

Referring to FIG. 1, network environment 100 may involve a UE 110, such as a mobile device or smartphone, in wireless communication with a wireless network 120 as part of a communication network. The wireless network 120 may be a public land mobile network (PLMN) including 5G/NR domain and 4G/LTE domain. UE 110 may initially be in wireless communication with wireless network 120 via a base station or network node 125 (e.g., an eNB, gNB or transmit-receive point (TRP)). In network environment 100, UE 110 and the wireless network 120 may implement various schemes pertaining to reenabling N1 mode capability after no slices being available in mobile communications in accordance with the present disclosure, as described herein.

It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately. Moreover, as used herein, a lower layer may refer to a layer in the 5GMM protocol stack that is lower than the radio resource control (RRC) layer, such as a packet data convergence protocol (PDCP) layer, a radio control link (RLC) layer, a medium access control (MAC) layer, a physical (PHY) layer, or so forth.

Under the proposed schemes in accordance with the present disclosure, UE 110 may disable the N1 mode capability for currently camped PLMN or standalone non-public network (SNPN) over a 3GPP access if no network slice is available for the camped PLMN or SNPN. If the disabling of N1 mode capability for the 3GPP access was due to no network slices being available, UE 110 may memorize the identity of the PLMN or SNPN where N1 mode is disabled due to no available network slices or a list of SNPNs where N1 mode is disabled due to no available network slices, respectively. Optionally, UE 110 may start a timer (e.g., timer T_{NSU}) for enabling the N1 mode capability that was disabled due to no available network slices for the 3GPP access. The value of this timer, timer T_{NSU}, may be UE implementation specific. Moreover, UE 110 may remove the memorized identity of the PLMNs or SNPNs where N1 mode was disabled due to no available network slice upon expiry of the timer T_{NSU}.

Under a first proposed scheme in accordance with the present disclosure, UE 110 may maintain a list of PLMNs where the N1 mode capability was disabled due to receipt of a reject from wireless network 120 with 5GMM cause #62 “No network slices available”, as PLMNs where no network slice was available in N1 mode for a 3GPP access. Moreover, under the first proposed scheme, when UE 110 disables its N1 mode capability due to receipt of a reject from wireless network 120 with 5GMM cause #62 “No network slices available”, UE 110 may add the identity of the PLMN (from which the reject with 5GMM cause #62 is received) to the list of PLMNs where no network slice was available in N1 mode for the 3GPP access and UE 110 may start a new timer (e.g., timer T_{NSU}) if timer T_{NSU} is not already running. The number of PLMNs that the UE 110 may store or memorize where no network slice was available in N1 mode for the 3GPP access may be implementation specific (e.g., at least one). The value of timer T_{NSU} may be UE implementation specific but may not exceed a maximum possible value of background scanning timer T as specified in 3GPP Technical Specification (TS) 23.122 clause 4.4.3.3.1.

Under a second proposed scheme in accordance with the present disclosure, UE 110 may maintain a list of PLMNs where the N1 mode capability was disabled due to receipt of a reject from wireless network 120 with 5GMM cause #62 “No network slices available”, as PLMNs where no network slice was available in N1 mode for a 3GPP access. Moreover, under the second proposed scheme, when UE 110 disables its N1 mode capability due to receipt of a reject from wireless network 120 with 5GMM cause #62 “No network slices available”, in case that UE 110 is in automatic PLMN selection mode, UE 110 may not consider PLMNs where no network slice was available in N1 mode for 3GPP access as PLMN selection candidates for next generation-radio access network (NG-RAN) access technology, unless no other PLMN is available. This does not prevent selection of such a PLMN if it is available in another radio access technology (RAT).

Under a third proposed scheme in accordance with the present disclosure, UE 110 may maintain a list of PLMNs where the N1 mode capability was disabled due to receipt of a reject from wireless network 120 with 5GMM cause #62 “No network slices available”, as PLMNs where no network slice was available in N1 mode for a 3GPP access. Moreover, under the third proposed scheme, when UE 110 disables its N1 mode capability due to receipt of a reject from wireless network 120 with 5GMM cause #62 “No network slices available”, in case that UE 110 is not configured to use timer T3245, UE 110 may maintain a list of PLMN-specific N1 mode attempt counters for 3GPP access as specified in 3GPP TS 24.501. Moreover, when timer T3247 expires, UE 110 may remove each PLMN-specific N1 mode attempt counter for 3GPP access that has a value greater than zero and less than a UE implementation-specific maximum value for the respective PLMN from the list of PLMNs where no network slice was available in N1 mode for 3GPP access.

Under a fourth proposed scheme in accordance with the present disclosure, UE 110 may maintain a list of PLMNs where the N1 mode capability was disabled due to receipt of a reject from wireless network 120 with 5GMM cause #62 “No network slices available”, as PLMNs where no network slice was available in N1 mode for a 3GPP access. Moreover, under the fourth proposed scheme, when UE 110 disables its N1 mode capability due to receipt of a reject from wireless network 120 with 5GMM cause #62 “No network slices available”, UE 110 may delete or otherwise remove the stored information on PLMNs (e.g., identities thereof) where no network slice was available in N1 mode for 3GPP access when UE 110 is switched off, when a USIM is removed from UE 110, or when timer T_{NSU} expires.

Under a fifth proposed scheme in accordance with the present disclosure, UE 110 may maintain a list of SNPNs where the N1 mode capability was disabled due to receipt of a reject from wireless network 120 with 5GMM cause #62 “No network slices available”. Moreover, under the fifth proposed scheme, when UE 110 disables its N1 mode capability due to receipt of a reject from an SNPN with 5GMM cause #62 “No network slices available”, UE 110 may add the identity of the SNPN identity of the SNPN which sent a reject with 5GMM cause #62 “No network slices available” to a list of SNPNs for which the N1 mode capability was disabled and UE 110 may start timer (e.g., timer T_{NSU}) if timer T_{NSU} is not already running. The number of SNPNs for which the N1 mode capability was disabled that E 110 may store is implementation specific but may be at least one. The value of timer T_{NSU} may be UE implementation specific.

Under a sixth proposed scheme in accordance with the present disclosure, UE 110 may maintain a list of SNPNs where the N1 mode capability was disabled due to receipt of a reject from wireless network 120 with 5GMM cause #62 “No network slices available”. Moreover, under the sixth proposed scheme, when UE 110 disables its N1 mode capability due to receipt of a reject from an SNPN with 5GMM cause #62 “No network slices available”, in case that UE 110 is in automatic SNPN selection mode, UE 110 may not select an SNPN for which the N1 mode capability was disabled as SNPN selection candidates, unless no other SNPN is available.

Under a seventh proposed scheme in accordance with the present disclosure, UE 110 may maintain a list of SNPNs where the N1 mode capability was disabled due to receipt of a reject from wireless network 120 with 5GMM cause #62 “No network slices available”. Moreover, under the seventh proposed scheme, when UE 110 disables its N1 mode capability due to receipt of a reject from an SNPN with 5GMM cause #62 “No network slices available”, in case that UE 110 is not configured to use timer T3245, UE 110 may maintain a list of SNPN-specific attempt counters for the 3GPP access as specified in 3GPP TS 24.501. Moreover, when timer T3247 expires, UE 110 may remove each SNPN-specific attempt counter for 3GPP access that has a value greater than zero and less than a UE implementation-specific maximum value for the respective SNPN from the list of SNPNs for which the N1 mode capability was disabled.

Under an eighth proposed scheme in accordance with the present disclosure, UE 110 may maintain a list of SNPNs where the N1 mode capability was disabled due to receipt of a reject from wireless network 120 with 5GMM cause #62 “No network slices available”. Moreover, under the eighth proposed scheme, when UE 110 disables its N1 mode capability due to receipt of a reject from an SNPN with 5GMM cause #62 “No network slices available”, UE 110 may delete or otherwise remove the stored information on SNPNs (e.g., identities thereof) for which the N1 mode capability was disabled when UE 110 is switched off, when a USIM is removed from UE 110, when the entries of the “list of subscriber data” for the SNPNs are updated, or when timer T_{NSU} expires.

It is noteworthy that, although the various proposed schemes are individually described above, in actual implementations, two or more of the proposed schemes may be implemented or executed jointly (e.g., sequentially or in parallel).

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to reenabling N1 mode capability after no slices being available in mobile communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network, or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged, and configured to perform specific tasks including those pertaining to reenabling N1 mode capability after no slices being available in mobile communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., network node 125) of a network (e.g., wireless network 120 as a 5G/NR mobile network), is provided below in the context of example processes 300 and 400.

### Illustrative Processes

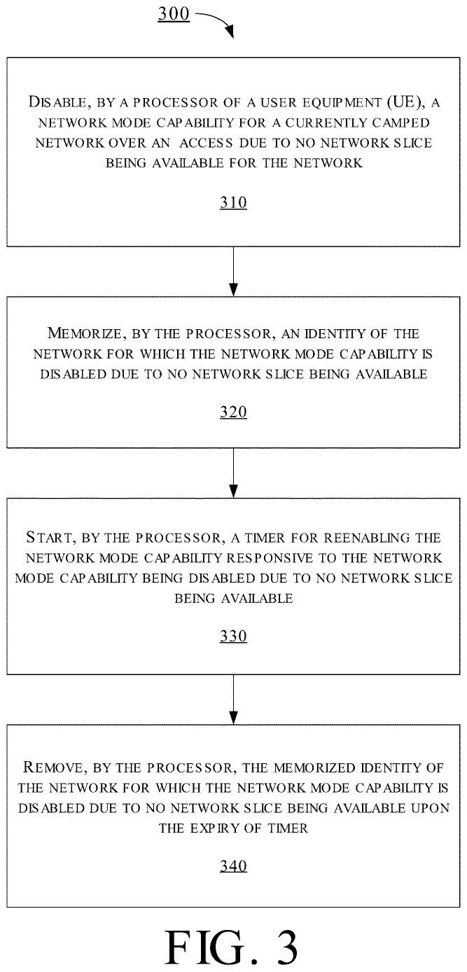

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to reenabling N1 mode capability after no slices being available in mobile communications in accordance with the present disclosure. Process 300 may include one or more operations, actions, or functions as illustrated by one or more of blocks 310, 320, 330 and 340. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively, in a different order. Furthermore, one or more of the blocks/sub-blocks of process 300 may be executed repeatedly or iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., network node 125) of a network (e.g., wireless network 120). Process 300 may begin at block 310.

At 310, process 300 may involve processor 212 of apparatus 210 disabling a network mode capability for a currently camped network over an access due to no network slice being available for the network. Process 300 may proceed from 310 to 320.

At 320, process 300 may involve processor 212 memorizing an identity of the network for which the network mode capability is disabled due to no network slice being available. Process 300 may proceed from 320 to 330.

At 330, process 300 may involve processor 212 starting a timer for reenabling the network mode capability responsive to the network mode capability being disabled due to no network slice being available. Process 300 may proceed from 330 to 340.

At 340, process 300 may involve processor 212 removing, by the processor, the memorized identity of the network for which the network mode capability is disabled due to no network slice being available upon expiring of the timer.

In some implementations, the network mode may be an N1 mode. In some implementations, the network may include a PLMN or SNPN. In some implementations, the access may include a 3GPP access or a non-3GPP access.

In some implementations, process 300 may also involve processor 212 receiving, transceiver 216, a reject message with a specific cause indicating no network slices available. In such cases, in disabling the network mode capability, process 300 may involve processor 212 disabling the network mode capability responsive to receiving the reject message.

In some implementations, in receiving the reject message, process 300 may involve processor 212 receiving a rejected NSSAI in a REGISTRATION REJECT message.

In some implementations, in receiving the reject message, process 300 may involve processor 212 receiving the rejected message during an initial registration procedure, a mobility registration procedure or a network-initiated de-registration procedure.

FIG. 4 illustrates an example process 400 in accordance with an implementation of the present disclosure. Process 400 may represent an aspect of implementing various proposed designs, concepts, schemes, systems and methods described above. More specifically, process 400 may represent an aspect of the proposed concepts and schemes pertaining to reenabling N1 mode capability after no slices being available in mobile communications in accordance with the present disclosure. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively, in a different order. Furthermore, one or more of the blocks/sub-blocks of process 400 may be executed repeatedly or iteratively. Process 400 may be implemented by or in apparatus 210 and apparatus 220 as well as any variations thereof. Solely for illustrative purposes and without limiting the scope, process 400 is described below in the context of apparatus 210 as a UE (e.g., UE 110) and apparatus 220 as a communication entity such as a network node or base station (e.g., network node 125) of a network (e.g., wireless network 120). Process 400 may begin at block 410.

At 410, process 400 may involve processor 212 of apparatus 210 disabling an N1 mode capability for a currently camped network over a type of access due to no network slice being available for the network. Process 400 may proceed from 410 to 420.

At 420, process 400 may involve processor 212 memorizing an identity of the network for which the N1 mode capability is disabled due to no network slice being available.

In some implementations, the network may include a PLMN or SNPN.

In some implementations, the type of access may include a 3GPP access or a non-3GPP access.

In some implementations, process 400 may also involve processor 212 receiving, transceiver 216, a reject message with a specific cause indicating no network slices available. In such cases, in disabling the N1 mode capability, process 300 may involve processor 212 disabling the N1 mode capability responsive to receiving the reject message.

In some implementations, in receiving the reject message, process 400 may involve processor 212 receiving a rejected NSSAI in a REGISTRATION REJECT message.

In some implementations, in receiving the reject message, process 400 may involve processor 212 receiving the rejected message during an initial registration procedure, a mobility registration procedure or a network-initiated de-registration procedure.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
disabling, by a processor of a user equipment (UE), a network mode capability for a currently camped network over an access due to no network slice being available for the network;
memorizing, by the processor, an identity of the network for which the network mode capability is disabled due to no network slice being available;
starting, by the processor, a timer for reenabling the network mode capability responsive to the network mode capability being disabled due to no network slice being available; and
removing, by the processor, the memorized identity of the network for which the network mode capability is disabled due to no network slice being available upon the expiry of timer.

2. The method of claim 1, wherein the network mode is N1 mode.

3. The method of claim 1, wherein the network comprises a public land mobile network (PLMN) or standalone non-public network (SNPN).

4. The method of claim 1, wherein the access comprises a 3^{rd} Generation Partnership Project (3GPP) access or a non-3GPP access.

5. The method of claim 1, further comprising:
receiving, by the processor, a reject message with a specific cause indicating no network slices available,
wherein the disabling of the network mode capability comprises disabling the network mode capability responsive to receiving the reject message.

6. The method of claim 5, wherein the receiving of the reject message comprises receiving a rejected network slice selection assistance information (NSSAI) in a REGISTRATION REJECT message.

7. The method of claim 5, wherein the receiving of the reject message comprises receiving the rejected message during an initial registration procedure, a mobility registration procedure or a network-initiated de-registration procedure.

8. A method, comprising:
disabling, by a processor of a user equipment (UE), an N1 mode capability for a currently camped network over a type of access due to no network slice being available for the network; and
memorizing, by the processor, an identity of the network for which the N1 mode capability is disabled due to no network slice being available.

9. The method of claim 8, wherein the network comprises a public land mobile network (PLMN) or standalone non-public network (SNPN).

10. The method of claim 8, wherein the type of access comprises a 3^{rd} Generation Partnership Project (3GPP) access or a non-3GPP access.

11. The method of claim 8, further comprising:
starting, by the processor, a timer for reenabling the N1 mode capability.

12. The method of claim 11, further comprising:
removing, by the processor, the identity of the PLMN or SNPN upon expiring of the timer.

13. The method of claim 8, further comprising:
receiving, by the processor, a reject message with a specific cause indicating no network slices available,
wherein the disabling of the N1 mode capability comprises disabling the N1 mode capability responsive to receiving the reject message.

14. The method of claim 13, wherein the receiving of the reject message comprises receiving a rejected network slice selection assistance information (NSSAI) in a REGISTRATION REJECT message.

15. The method of claim 13, wherein the receiving of the reject message comprises receiving the rejected message during an initial registration procedure, a mobility registration procedure or a network-initiated de-registration procedure.

16. An apparatus implementable in a user equipment (UE), comprising:
a transceiver configured to communicate wirelessly; and
a processor coupled to the transceiver and configured to perform operations comprising:
disabling an N1 mode capability for a currently camped public land mobile network (PLMN) or standalone non-public network (SNPN) over a 3^{rd} Generation Partnership Project (3GPP) access due to no network slice being available for the PLMN or SNPN; and
memorizing an identity of the PLMN or SNPN for which the N1 mode capability is disabled due to no network slice being available.

17. The apparatus of claim 16, wherein the processor is further configured to perform operations comprising:
starting a timer for reenabling the N1 mode capability.

18. The apparatus of claim 17, wherein the processor is further configured to perform operations comprising:
removing the identity of the PLMN or SNPN upon expiring of the timer.

19. The apparatus of claim 16, wherein the processor is further configured to perform operations comprising:
receiving, via the transceiver, a reject message with a specific cause indicating no network slices available, wherein the disabling of the N1 mode capability comprises disabling the N1 mode capability responsive to receiving the reject message.

20. The apparatus of claim 10, wherein the receiving of the reject message comprises:
receiving a rejected network slice selection assistance information (NSSAI) in a REGISTRATION REJECT message; or
receiving the rejected message during an initial registration procedure, a mobility registration procedure or a network-initiated de-registration procedure.
